(19) United States
(12) Patent Application Publication
(10) Pub. No.: US 2021/0088941 A1
(43) Pub. Date: Mar. 25, 2021

(54) IMAGE FORMING APPARATUS

(71) Applicant: FUJI XEROX CO., LTD., Tokyo (JP)

(72) Inventors: Kazuki KISHI, Ebina-shi (JP); Tsutomu KOMIYAMA, Ebina-shi (JP)

(73) Assignee: FUJI XEROX CO., LTD., Tokyo (JP)

(21) Appl. No.: 16/827,016

(22) Filed: Mar. 23, 2020

(30) Foreign Application Priority Data
Sep. 20, 2019 (JP) 2019-171005

(51) Int. Cl. G03G 15/16

(52) U.S. Cl. CPC G03G 15/161

(57) ABSTRACT

An image forming apparatus includes: multiple image forming units that form toner images; an intermediate transfer belt that rotates so as to pass through the image forming units; multiple first-transfer rollers that are provided in a manner capable of being displaced between transfer positions, where the first-transfer rollers make the intermediate transfer belt come into contact with the image forming units, and retracted positions, where the first-transfer rollers make the intermediate transfer belt be separated from the image forming units, and that first-transfer the toner images to the intermediate transfer belt when the first-transfer rollers are located at the transfer positions; a displacement mechanism including a moving unit that comes into contact with and moves a first-transfer roller that is not involved in transfer in a first mode, in which an image is formed with one image forming unit, among the first-transfer rollers of the image forming units, so as to be displace the first transfer roller to the retracted position, and a rotating cam that comes into contact with a portion of the moving unit to move the moving unit in the first mode; and upstream-side and downstream-side retention rollers in contact with an inner circumferential surface of the intermediate transfer belt and supporting passing positions of the intermediate transfer belt at a position immediately upstream of the first-transfer roller that is disposed on the extreme upstream side in the rotation direction of the intermediate transfer belt and a position immediately downstream of the first-transfer roller that is disposed on the extreme downstream side in the rotation direction of the intermediate transfer belt, respectively. In a second mode, in which an image is formed with two or more image forming units of the image forming units, and when all the first-transfer rollers are located at the transfer positions, the displacement mechanism adjusts the passing position of the intermediate transfer belt by bringing a portion of the rotating cam into contact with the moving unit to move the moving unit and thus displacing one of the upstream-side and downstream-side retention rollers.

### CROSS-REFERENCE TO RELATED APPLICATIONS

This application is based on and claims priority under 35 USC 119 from Japanese Patent Application No. 2019-171005 filed Sep. 20, 2019.

### BACKGROUND

### (i) Technical Field

The disclosure relates to an image forming apparatus.

### (ii) Related Art

Japanese Unexamined Patent Application Publication No. 2007-178864 discloses an image forming apparatus in which adjustment related to an intermediate transfer belt is performed.

The image forming apparatus disclosed therein is a tandem-type color image forming apparatus in which an intermediate transfer belt stretched between a driving roller and a driven roller is shifted toward one end or the other end of the driving roller and the driven roller by differentiating the tension at one end and the other end in the width direction. By changing the orientation of a roller, other than the driving roller or the driven roller, in contact with the intermediate transfer belt, color mode and monochrome mode are switched, and the shifting direction of the intermediate transfer belt is switched. This image forming apparatus extends the life of the intermediate transfer belt.

### SUMMARY

Aspects of non-limiting embodiments of the present disclosure relate to providing an image forming apparatus in which it is possible to suppress, by using a mechanism for displacing one of multiple first-transfer rollers between a transfer position and a retracted position via a moving unit that comes into contact with and is moved by a rotating cam, image misregistration in the axial direction due to unstable running of an intermediate transfer belt when an image is formed with two or more image forming units.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: multiple image forming units that form toner images; an intermediate transfer belt that rotates so as to pass through the image forming units; multiple first-transfer rollers that are provided in a manner capable of being displaced between transfer positions, where the first-transfer rollers make the intermediate transfer belt come into contact with the image forming units, and retracted positions, where the first-transfer rollers make the intermediate transfer belt be separated from the image forming units, and that first-transfer the toner images to the intermediate transfer belt when the first-transfer rollers are located at the transfer positions; a displacement mechanism including a moving unit that comes into contact with and moves a first-transfer roller that is not involved in transfer in a first mode, in which an image is formed with one image forming unit, among the first-transfer rollers of the image forming units, so as to be displace the first transfer roller to the retracted position, and a rotating cam that comes into contact with a portion of the moving unit to move the moving unit in the first mode; and upstream-side and downstream-side retention rollers in contact with an inner circumferential surface of the intermediate transfer belt and supporting passing positions of the intermediate transfer belt at a position immediately upstream of the first-transfer roller that is disposed on the extreme upstream side in the rotation direction of the intermediate transfer belt and a position immediately downstream of the first-transfer roller that is disposed on the extreme downstream side in the rotation direction of the intermediate transfer belt, respectively. In a second mode, in which an image is formed with two or more image forming units of the image forming units, and when all the first-transfer rollers are located at the transfer positions, the displacement mechanism adjusts the passing position of the intermediate transfer belt by bringing a portion of the rotating cam into contact with the moving unit to move the moving unit and thus displacing one of the upstream-side and downstream-side retention rollers.

### BRIEF DESCRIPTION OF THE DRAWINGS

Exemplary embodiment of the present disclosure will be described in detail based on the following figures, wherein:

FIG. 1 schematically shows an image forming apparatus according to a first exemplary embodiment and the like;

FIG. 2 is a schematic perspective view of an intermediate transfer device of the image forming apparatus in FIG. 1;

FIGS. 3A and 3B are schematic sectional views of the intermediate transfer device, taken along line III-III in FIG. 2, showing a state in a multicolor mode and a state in a monochrome mode, respectively;

FIG. 4 is a schematic perspective view of the intermediate transfer device in FIG. 2, without the intermediate transfer belt;

FIG. 5 is a plan view of the intermediate transfer device in FIG. 4 and other configurations;

FIG. 6 is a partial enlarged schematic sectional view of a displacement mechanism;

FIG. 7 is a partial enlarged schematic plan view of the displacement mechanism;

FIG. 8 is a partial enlarged schematic perspective view of the displacement mechanism;

FIG. 9 is a schematic sectional view showing the configuration of an end of the intermediate transfer belt;

FIG. 10 is a schematic sectional view showing the configuration of a rotating cam having an adjustment action portion and portions adjacent thereto in the displacement mechanism;

FIGS. 11A and 11B are schematic sectional views showing a state of a portion of the displacement mechanism in the multicolor mode and in the monochrome mode, respectively; and

FIG. 12 schematically shows a state when the displacement mechanism adjusts a passing position of the intermediate transfer belt.

### DETAILED DESCRIPTION

Exemplary embodiments of the disclosure will be described below with reference to the drawings.

### First Exemplary Embodiment

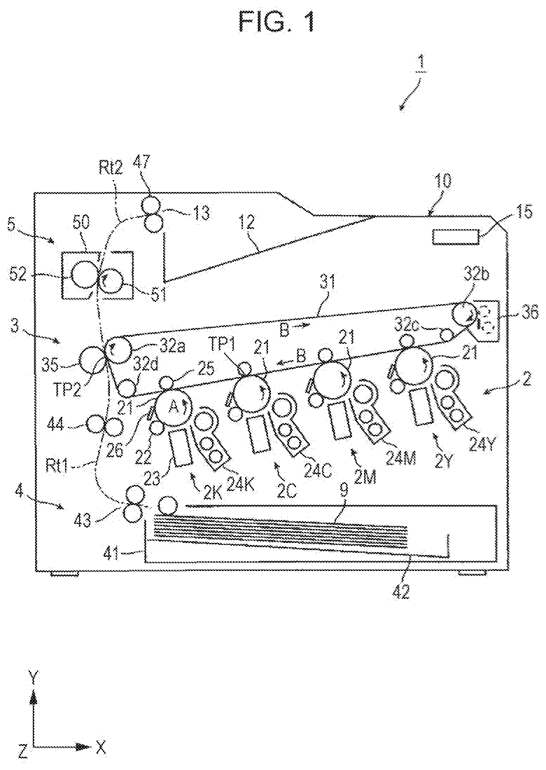

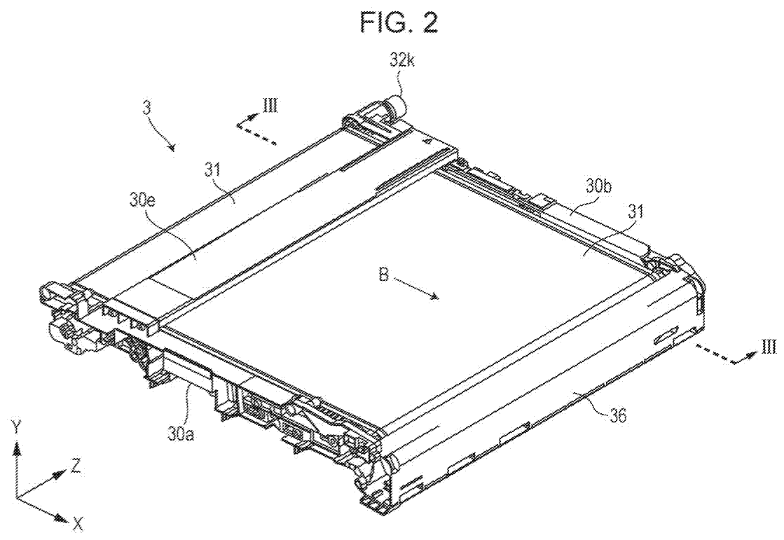

FIGS. 1 and 2 show an image forming apparatus 1 according to the first exemplary embodiment. FIG. 1 shows the overall configuration of the image forming apparatus 1, and FIG. 2 shows the configuration of a portion (an intermediate transfer device and a first-transfer roller) of the image forming apparatus 1.

The arrows X, Y, and Z in the drawings represent the width, height, and depth directions in a three-dimensional space assumed therein. Furthermore, the circle at the point of intersection between the arrows X and Y indicates that the Z direction is perpendicular to the plane of the drawing.

### Overall Configuration of Image Forming Apparatus

The image forming apparatus 1 forms an image formed of toner, serving as developer, on a sheet 9, serving as an example of a recording medium. The image forming apparatus 1 according to the first exemplary embodiment is, for example, a printer that forms an image corresponding to image information inputted from an external device, such as an information terminal or the like.

As shown in FIG. 1, the image forming apparatus 1 includes, inside a housing 10: an image forming unit 2 that forms a toner image based on image information; an intermediate transfer device 3 that temporarily carries the toner image formed by the image forming unit 2 and from which the toner image is second-transferred to a sheet 9; a paper feed unit 4 that accommodates and supplies sheets 9 to be supplied to the second-transfer position of the intermediate transfer device 3; and a fixing device 5 that fixes the toner image second-transferred from the intermediate transfer device 3 to the sheet 9. The image forming apparatus 1 employs a so-called intermediate transfer method, in which a toner image formed by the image forming unit 2 is transferred to a sheet 9 via the intermediate transfer device 3.

The image information is information related to images, such as text, graphics, photographs, patterns, etc. The housing 10 is a structure formed in a certain shape by combining various materials, such as support members and exterior members. The housing 10 has, in one portion of the top surface thereof, a discharged-sheet storing part 12 that accommodates, in a stacked state, sheets 9 discharged after images are formed thereon, and a discharge port 13 through which the sheet 9 is discharged to the discharged-sheet storing part 12. The one-dot chain line in FIG. 1 shows a transport path along which a sheet 9 is transported in the housing 10.

The image forming unit 2 includes four image forming units 2Y, 2M, 2C, and 2K, which are dedicated to form yellow (Y), magenta (M), cyan (C), and black (K) toner images, respectively.

The four image forming units 2 (Y, M, C, and K) each include a photoconductive drum 21, serving an example of an image carrier, rotated in the direction of arrow A and include, around the photoconductive drum 21, a charging device 22, an exposure device 23, a developing device 24 (Y, M, C, or K), a first-transfer device 25, a drum cleaning device 26, and the like. In FIG. 1, all the reference signs 21 to 26 for the image forming unit 2K are shown, and some reference signs for the other image forming units 2 (Y, M, and C) are omitted.

The charging device 22 charges the outer circumferential surface (i.e., the surface on which an image can be formed) of the photoconductive drum 21 to a certain surface electric potential. The exposure device 23 radiates light onto the outer circumferential surface of the photoconductive drum 21 according to the image information and forms an electrostatic latent image corresponding to a certain color component (Y, M, C, or K).

The developing device 24 (Y, M, C, or K) develops the electrostatic latent image formed on the outer circumferential surface of the photoconductive drum 21 with developer (toner) of the corresponding color (Y, M, C, or K), thus forming a toner image.

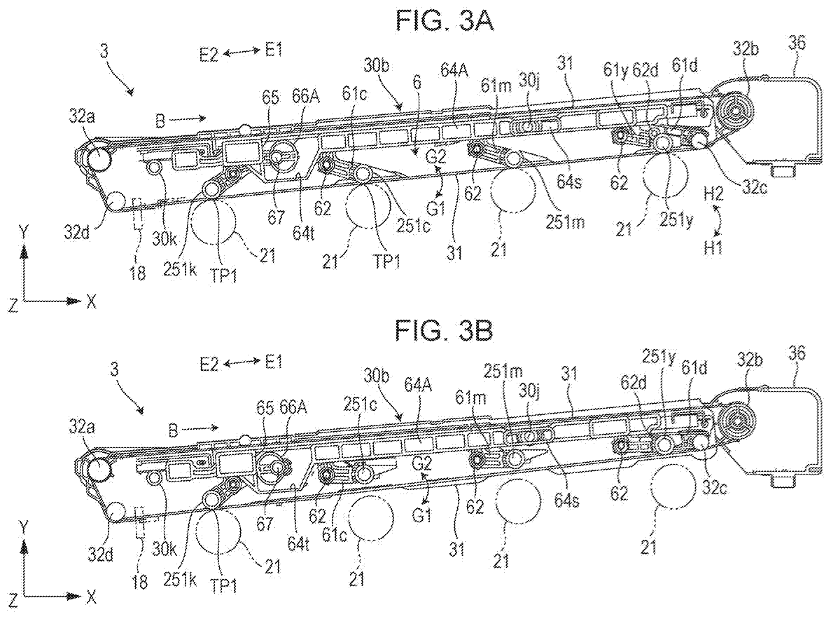

The first-transfer devices 25 electrostatically transfer the color toner images to the intermediate transfer device 3 (intermediate transfer belt 31). As shown in FIGS. 3A and 3B, the first-transfer devices 25 according to the first exemplary embodiment include first-transfer rollers 251y, 251m, 251c, and 251k, which are an example of a contact transfer member to which a first-transfer current is supplied. The drum cleaning devices 26 scrape off undesired substances on the outer circumferential surfaces of the photoconductive drums 21, such as undesired toner and paper dust, to clean the outer circumferential surfaces of the photoconductive drums 21.

In the image forming units 2 (Y, M, C, and K), the portions where the photoconductive drums 21 and the first-transfer rollers 251y, 251m, 251c, and 251k of the first-transfer devices 25 are opposed to each other with the intermediate transfer belt 31 therebetween are first-transfer positions TP1, where the toner images are first-transferred.

The intermediate transfer device 3 temporarily carries the color toner images formed by the image forming units 2 (Y, M, C, and K) and first-transferred thereto, transports the color toner images to the position where they are second-transferred to a sheet 9 and allows the color toner images to be second-transferred to the sheet 9.

The intermediate transfer device 3 according to the first exemplary embodiment is disposed above the image forming units 2 (Y, M, C, and K), inside the housing 10. As shown in FIGS. 1 to 3 etc., the intermediate transfer device 3 includes the intermediate transfer belt 31 to which the toner images are first-transferred from the photoconductive drums 21 of the image forming units 2 (Y, M, C, and K) and has components described below around the intermediate transfer belt 31.

The intermediate transfer belt 31 is supported by multiple support rollers 32a to 32d disposed inside thereof so as to be able to rotate (run) in the direction of arrow B while sequentially passing through the first-transfer positions corresponding to the image forming units 2 (Y, M, C, and K).

Of the multiple support rollers 32a to 32d, the support roller 32a serves as a driving roller, as well as a second-transfer backup roller, the support roller 32b serves as a tension roller that applies tension, and the support rollers 32c and 32d serve as retention rollers that support the passing position of the intermediate transfer belt 31.

The first-transfer devices 25 (first-transfer rollers 251) corresponding to the image forming units 2 (Y, M, C, and K) are disposed inside the intermediate transfer belt 31. The first-transfer devices 25 constitute a part of the intermediate transfer device 3.

A second-transfer device 35 is disposed on the outer circumferential surface of the intermediate transfer belt 31, at a portion supported by the support roller 32a. The second-transfer device 35 second-transfers the toner image on the intermediate transfer belt 31 to a sheet 9 while allowing the sheet 9 to pass therethrough. The second-transfer device 35 according to the first exemplary embodiment includes a second-transfer roller, serving as an example of a contact transfer member to which a second-transfer current is supplied, and allows the sheet 9 to pass therethrough while pressing the sheet 9 against the outer circumferential surface portion of the intermediate transfer belt 31 supported by the support roller 32a.

Furthermore, a belt cleaning device 36 is disposed outside the intermediate transfer belt 31. The belt cleaning device 36 removes undesired substances, such as residual toner remaining on the outer circumferential surface of the intermediate transfer belt 31 after the second transfer, to clean the outer circumferential surface of the intermediate transfer belt 31.

In the intermediate transfer device 3, the portion where the second-transfer device 35 (second-transfer roller) and the outer circumferential surface of the intermediate transfer belt 31 are in contact with each other is a second-transfer position TP2, where the toner image is second-transferred to the sheet 9.

In the intermediate transfer device 3, as shown in FIGS. 3A and 3B etc., the support rollers 32a to 32d and the first-transfer rollers 251y, 251m, 251c, and 251k of the first-transfer devices 25 are provided, so as to be at least rotatable, on a support frame 30 (left and right side-surface portions 30a and 30b) of the intermediate transfer device 3.

The paper feed unit 4 accommodates and supplies sheets 9 to be supplied to the second-transfer position TP2 of the intermediate transfer device 3. The paper feed unit 4 is disposed below the image forming units 2 (Y, M, C, and K) inside the housing 10 and includes a container 41 for the sheets 9 and other devices, such as a feed device 43.

The container 41 includes a loading plate 42 on which multiple sheets 9 are loaded in a certain orientation and is attached such that it can be pulled out of the housing 10 to supply sheets 9. The feed device 43 feeds the sheets 9 on the loading plate 42 of the container 41 one-by-one from the top with a paper feed device including multiple rollers. The sheet 9 is any recording medium, such as normal paper, coated paper, and cardboard, that can be transported in the housing 10 of the image forming apparatus 1 and onto which a toner image can be transferred and fixed. The material, shape, and the like of the sheets 9 are not specifically limited.

The fixing device 5 fixes, to the sheet 9, the toner image second-transferred by the intermediate transfer device 3. The fixing device 5 is disposed above the second-transfer position TP2 of the intermediate transfer device 3 inside the housing 10. More specifically, the fixing device 5 includes: a housing 50 having a sheet introduction port and a sheet discharge port, a heating rotary member 51, a pressure rotary member 52, and the like disposed in the housing 50.

The heating rotary member 51 is a rotary member having a roller shape, a belt-pad shape, or the like and is rotated in the direction indicated by the arrow while being heated by a heating device (not shown) such that the outer surface thereof is maintained at a certain temperature. The pressure rotary member 52 is a rotary member having a roller shape, a belt-pad shape, or the like and is rotated in a driven manner while being pressed against the heating rotary member 51 at a certain pressure. The pressure rotary member 52 may also be heated by a heating device.

In the fixing device 5, the portion where the heating rotary member 51 and the pressure rotary member 52 are in contact with each other serves as a nip portion (fixing processing portion) where processing, such as heating and pressing, for fixing an unfixed toner image to the sheet 9 is performed.

As shown in FIG. 1, a feeding transport path Rt1 along which a sheet 9 in the paper feed unit 4 is transported so as to be supplied to the second-transfer position TP2, and a discharging transport path Rt2 along which the sheet 9 after fixing is transported so as to be discharged on the discharged-sheet storing part 12 through the discharge port 13 in the housing 10 are provided inside the housing 10 of the image forming apparatus 1.

As shown in FIG. 1, the feeding transport path Rt1 includes a pair of transport rollers 44 that nip and transport the sheet 9, a guide member (not shown) that guides the transportation of the sheet 9 while ensuring the transport space for the sheet 9, and the like. The discharging transport path Rt2 includes a pair of discharging rollers 47 disposed upstream of the discharge port 13, a guide member (not shown) that guides the transportation of the sheet 9 while ensuring the transport space for the sheet 9, and the like.

The image forming apparatus 1 operates in two modes: a multicolor mode, serving an example of a second mode, in which all the four image forming units 2 (Y, M, C, and K) are operated to form a multicolored image (full-color image) formed by combining four color toner images (Y, M, C, K); and a monochrome mode, serving an example of a first mode, in which only one, 2K in this example, of the four image forming units 2 (Y, M, C, and K) is operated to form a monochrome image (black-color image) formed of a monochrome toner image (K: black). By selecting from the multicolor mode and the monochrome mode, an image of a desired color can be formed.

As shown in FIGS. 3A and 3B, in the image forming apparatus 1, at least the first-transfer rollers 251y, 251m, and 251c of the first-transfer devices 25 can be displaced between transfer positions, where the intermediate transfer belt 31 is in contact with the photoconductive drums 21 of the image forming units 2 (Y, M, C), and retracted positions, where the intermediate transfer belt 31 is separated from the photoconductive drums 21.

In this image forming apparatus 1, in the multicolor mode, all the four first-transfer rollers 251y, 251m, 251c, and 251k are displaced to the transfer positions, as shown in FIG. 3A. In the monochrome mode, three first-transfer rollers, 251y, 251m, and 251c, other than the first-transfer roller 251k for black, which are not used for the first transfer in forming a monochrome (black-color) image, are displaced to the retracted positions, as shown in FIG. 3B. The first-transfer roller 251k for black can also be displaced to a retracted position when, for example, the intermediate transfer device 3 is removed from the housing 10.

Configuration of First-Transfer-Roller Displacement Mechanism

The image forming apparatus 1 includes a displacement mechanism 6 that displaces the three first-transfer rollers 251y, 251m, and 251c between the transfer positions and the retracted positions.

As shown in FIGS. 3A and 3B, 4, 6, etc., the displacement mechanism 6 includes: swing support members 61y, 61m, and 61c that support the three first-transfer rollers 251y, 251m, and 251c so as to swing between the transfer positions and the retracted positions; sliders 64, serving as an example of a moving unit, that come into contact with and move contact projections 63, constituting portion of the swing support members 61y, 61m, and 61c, so as to displace the first-transfer rollers 251y, 251m, and 251c, which are not used in transfer in the monochrome mode, to the retracted positions; rotating cams 66 that, in the monochrome mode, rotate so as to come into contact with cam contact portions 65, constituting portion of the move sliders 64, to move the sliders 64; and a cam driver 17, serving an example of a cam driving part, that rotationally drives the rotating cams 66 (more specifically, a rotary shaft 67, described below, supporting the rotating cams 66) so as to adjust the rotation angles of the rotating cams 66.

As shown in FIGS. 3A and 3B, 5, 6, etc., the swing support members 61y, 61m, and 61c are formed of L-shaped plate-like members having a bent portion. The swing support members 61y, 61m, and 61c each include a right member and a left member, forming a pair, so as to support both ends of the first-transfer rollers 251y, 251m, and 251c. More specifically, the swing support members 61y, 61m, and 61c each include left and right swing support members facing each other and disposed on the outer side of the left and right ends of the intermediate transfer belt 31 parallel to the rotation direction B thereof.

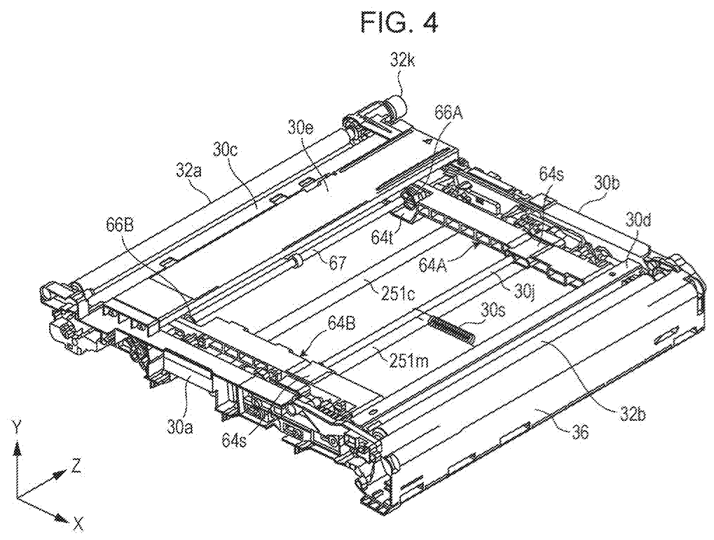

The swing support members 61y, 61m, and 61c are attached at the bent portions thereof to support shafts 62 so as to be pivotable and swing about the support shafts 62 in the directions of arrows G1 and G2. The support shafts 62 are provided on the inner surfaces of the left and right side-surface portions 30a and 30b of the support frame 30 of the intermediate transfer device 3 so as to face each other. Reference signs 30c and 30d in FIG. 4, etc. denote connecting frames of the support frame 30, and reference sign 30e denotes an upper attachment frame plate of the support frame 30.

The swing support members 61y, 61m, and 61c have, at first ends, which are ends of portions extending toward one side (for example, upward) from the bent portions, structures for supporting the shaft ends of the first-transfer rollers 251y, 251m, and 251c.

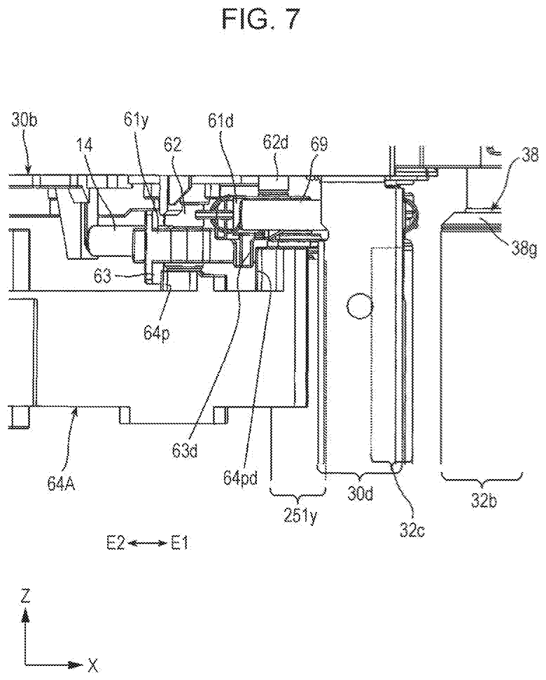

The swing support members 61y, 61m, and 61c have, at second ends, which are ends of portions extending toward another side (for example, sideward) from the bent portions, the contact projections 63 that can be brought into contact with action projections (64p) (described below) of the sliders 64. Ends of elastic members 14 (FIG. 7), such as coil springs, for applying a certain pressure so as to press the intermediate transfer belt 31 against the photoconductive drums 21 when the first-transfer rollers 251y, 251m, and 251c are located at the transfer positions are attached to the second ends. With this configuration, the swing support members 61y, 61m, and 61c are urged so as to swing in the direction of arrow G1 by the tension from the elastic member 14.

As shown in FIGS. 4 to 6, etc., the sliders 64 are elongated members extending in the rotation direction B of the intermediate transfer belt 31. The sliders 64 include left and right sliders 64A and 64B, which are disposed on the inner side of the left and right ends of the intermediate transfer belt 31 parallel to the rotation direction B thereof. More specifically, the left and right sliders 64A and 64B are disposed on the inner side of the left and right side-surface portions 30a and 30b of the support frame 30 of the intermediate transfer device 3 so as to be slidable in the directions of arrows E1 and E2.

As shown in FIGS. 3A and 3B, 4, etc., the left and right sliders 64A and 64B are supported so as to be slidable in a state in which a slide support rod 30j fixed to the left and right side-surface portions 30a and 30b of the support frame 30 of the intermediate transfer device 3 extends through slide elongated holes 64s provided at intermediate portions of the left and right sliders 64A and 64B, the portions being closer to the support roller 32b in the longitudinal direction. FIG. 4 shows a coil spring 30s. The coil spring 30s is attached at one end thereof to the slide support rod 30j and at the other end thereof to the connecting frame 30d and applies a certain tension to the slide support rod 30j.

Furthermore, as shown in FIGS. 3A and 3B, etc., the ends of the left and right sliders 64A and 64B closer to the support roller 32a in the longitudinal direction are disposed on a support rod 30k fixed to the left and right side-surface portions 30a and 30b of the support frame 30 of the intermediate transfer device 3 and are supported from below so as to be slidable.

Furthermore, as shown in FIGS. 3A and 3B, 5, 6, etc., the left and right sliders 64A and 64B have the cam contact portions 65, serving as wall portions with which the rotating cams 66 come into contact and act thereon, are provided at intermediate portions thereof closer to the support roller 32a in the longitudinal direction. The left and right sliders 64A and 64B have accommodating recesses 64t, including the cam contact portions 65, in which the rotating cams 66 are accommodated.

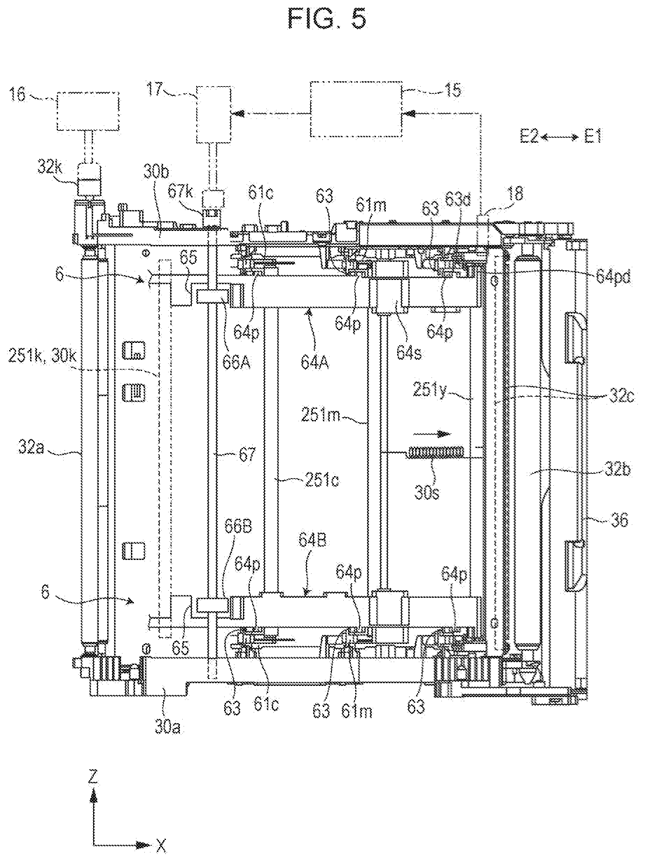

Furthermore, as shown in FIGS. 5, 7, etc., the left and right sliders 64A and 64B have, on the side surfaces thereof, action projections 64p that come into contact with the contact projections 63 of the swing support members 61y, 61m, and 61c to move the swing support members 61y, 61m, and 61c in the direction of arrow G2 (direction toward the retracted positions).

In the multicolor mode, the left and right sliders 64A and 64B are not in contact with the rotating cams 66 and are movable in the direction of arrow E1. In the first exemplary embodiment, in the multicolor mode, the contact projections 63 of the swing support members 61y, 61m, and 61c urged in the direction of arrow G1 are in contact with the action projections 64p of the left and right sliders 64A and 64B to urge the left and right sliders 64A and 64B in the direction of arrow E1.

The rotating cams 66 are configured as cams that are rotated by a rotary shaft. The rotating cams 66 include left and right rotating cams 66A and 66B that come into contact with and act on the cam contact portions 65 of the left and right sliders 64A and 64B.

As shown in FIGS. 4, 5, etc., the left and right rotating cams 66A and 66B are fixed to the single rotary shaft 67 at two positions.

The rotary shaft 67 is rotatably supported between the left and right side-surface portions 30a and 30b of the support frame 30 of the intermediate transfer device 3. The rotary shaft 67 is disposed so as to penetrate through elongated holes provided in side surfaces of the accommodating recesses 64t in the left and right sliders 64A and 64B.

More specifically, the left and right rotating cams 66A and 66B are attached to portions of the rotary shaft 67, the portions being located inside the accommodating recesses 64t in the left and right sliders 64A and 64B and, thus, can come into contact with the cam contact portions 65.

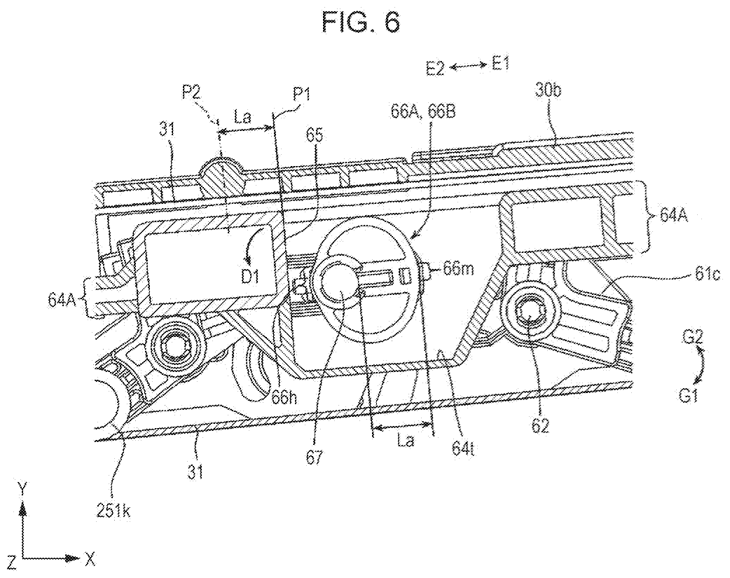

The left and right rotating cams 66A and 66B have the same shape, as shown in FIGS. 3A and 3B, 6, etc., except that one of them has a portion described below (i.e., an adjustment action portion).

The left and right rotating cams 66A and 66B according to the first exemplary embodiment include principal action portions 66m, which come into contact with the cam contact portions 65 of the left and right sliders 64A and 64B to move the left and right sliders 64A and 64B in the direction of arrow E2 in the monochrome mode, and non-contact portions 66h, which do not come into contact with the cam contact portions 65 of the left and right sliders 64A and 64B and thus allow the left and right sliders 64A and 64B to be movable in the direction of arrow E1 in the multicolor mode.

As shown by a two-dot chain line in FIG. 5, an end of the rotary shaft 67 located on the far side (i.e., the side pointed by arrow Z) of the intermediate transfer device 3 is connected to a driving shaft of the cam driver 17 via a removable connector (e.g., a coupling) 67k. The cam driver 17 includes a stepping motor, a reduction mechanism, and the like and is controlled by the control unit 15.

When the image forming apparatus 1 is switched from the monochrome mode to the multicolor mode and when the image forming apparatus 1 is switched from the multicolor mode to the monochrome mode, a rotational force is transmitted from the cam driver 17, which is driven under the control of the control unit 15, to the rotary shaft 67, rotating the rotary shaft 67 by a certain angle in the predetermined direction (at least in the direction indicated by arrow D1).

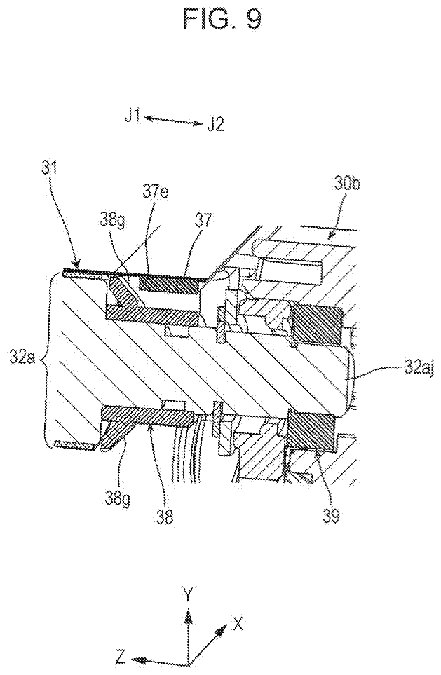

As shown in FIG. 9, in the intermediate transfer device 3, the intermediate transfer belt 31 has belt ribs 37 extending in the circumferential direction, at the left and right ends of the inner circumferential surface thereof. The belt ribs 37 are long, narrow members having a rectangular sectional view. The support rollers 32a and 32b have, on the left and right ends thereof, rib guides 38 having inclined guide surfaces 38g (frusto-conical circumferential surface as a whole) that guide the belt ribs 37 when the belt ribs 37 come into contact therewith.

With this configuration, if the intermediate transfer belt 31 is shifted toward the left side or the right side while running, one of the left and right belt ribs 37 comes into contact with the guide surface 38g of the rib guide 38 and temporarily runs thereon, and is then guided to the original position by the inclined guide surfaces 38g.

In the displacement mechanism 6, when the image forming apparatus 1 is switched from the monochrome mode to the multicolor mode to perform an image forming operation, as shown in FIG. 3A, the left and right rotating cams 66A and 66B are rotated by a certain angle by the rotation of the rotary shaft 67, such that the non-contact portions 66h face the cam contact portions 65 of the left and right sliders 64A and 64B, so as not to be in contact with the cam contact portions 65. As a result, because the left and right sliders 64A and 64B are not subjected to an action from the left and right rotating cams 66A and 66B, the left and right sliders 64A and 64B are moved in the direction of arrow E1 by receiving the urging force from the swing support members 61y, 61m, and 61c urged in the direction of arrow G1.

As a result, in the displacement mechanism 6, as shown in FIGS. 3A and 6, the swing support members 61y, 61m, and 61c swing in the direction of arrow G1 about the support shafts 62, displacing the first-transfer rollers 251y, 251m, and 251c from the retracted positions to the transfer positions.

Thus, in the multicolor mode, the four first-transfer rollers 251y, 251m, 251c, and 251k are located at the transfer positions, enabling first transfer in the four image forming units 2Y, 2M, 2C, and 2K.

Furthermore, in the displacement mechanism 6, as shown in FIG. 3B, when the image forming apparatus 1 is switched from the multicolor mode to the monochrome mode to perform an image forming operation, the left and right rotating cams 66A and 66B are rotated by a certain angle by the rotation of the rotary shaft 67, such that the principal action portions 66m face the cam contact portions 65 of the left and right sliders 64A and 64B, so as to be in contact with the cam contact portions 65.

As a result, the left and right sliders 64A and 64B are subjected to an action from the principal action portions 66m of the left and right rotating cams 66A and 66B, and the left and right sliders 64A and 64B are moved in the direction of arrow E2, against the urging force applied by the swing support members 61y, 61m, and 61c urged in the direction of arrow G1.

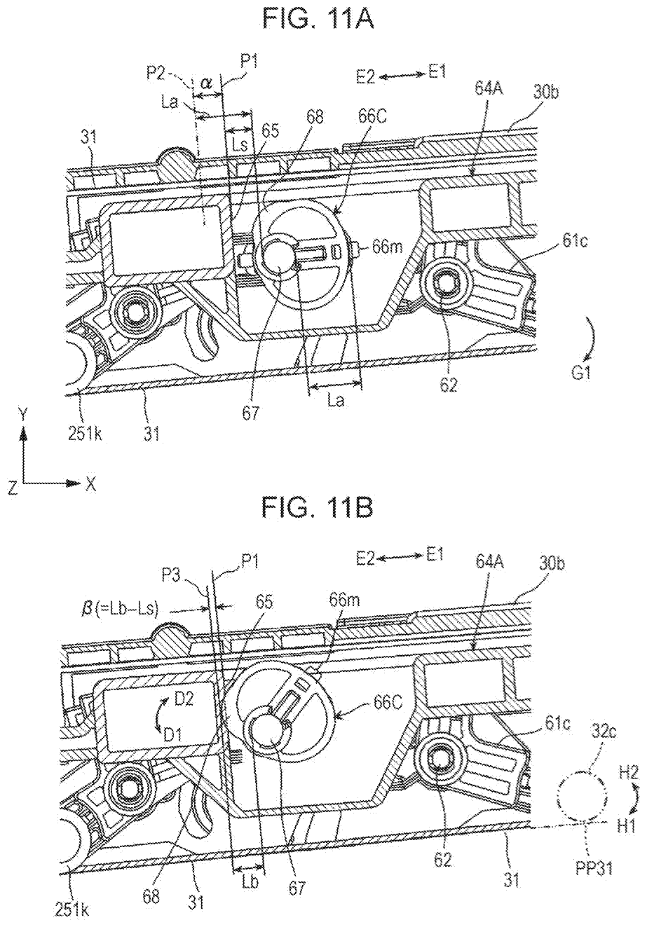

At this time, as shown in FIGS. 6 and 11A, when the apexes of the principal action portions 66m of the left and right rotating cams 66A and 66B are located at a distance La from the rotary shaft 67, the left and right sliders 64A and 64B are moved by a maximum distance, α, in the direction of arrow E2. The maximum distance α is a value obtained by subtracting a distance Ls, which is the distance between the rotary shaft 67 and a position P1 where the cam contact portions 65 of the left and right sliders 64A and 64B are stopped when located at the transfer positions in the multicolor mode, from the distance La (La-Ls). Reference sign P2 in FIG. 6, etc., indicates the position of the cam contact portions 65 that have been moved to a maximum, at the retracted positions in the monochrome mode.

As a result, in the displacement mechanism 6, as shown in FIG. 3B, the swing support members 61y, 61m, and 61c swing in the direction of arrow G2 about the support shafts 62, displacing the first-transfer rollers 251y, 251m, and 251c from the transfer positions to the retracted positions.

Accordingly, in the monochrome mode, only the first-transfer roller 251k for black is located at the transfer position, and three other first-transfer rollers, 251y, 251m, and 251c, that are not involved in transferring toner images are moved to the retracted positions, so that only first transfer in the image forming unit 2K for black is enabled. In this state, first transfer in the other image forming units, 2Y, 2M, and 2C, cannot be performed.

### Configuration Related to Adjustment of Intermediate-Transfer-Belt Passing Position by Displacement Mechanism

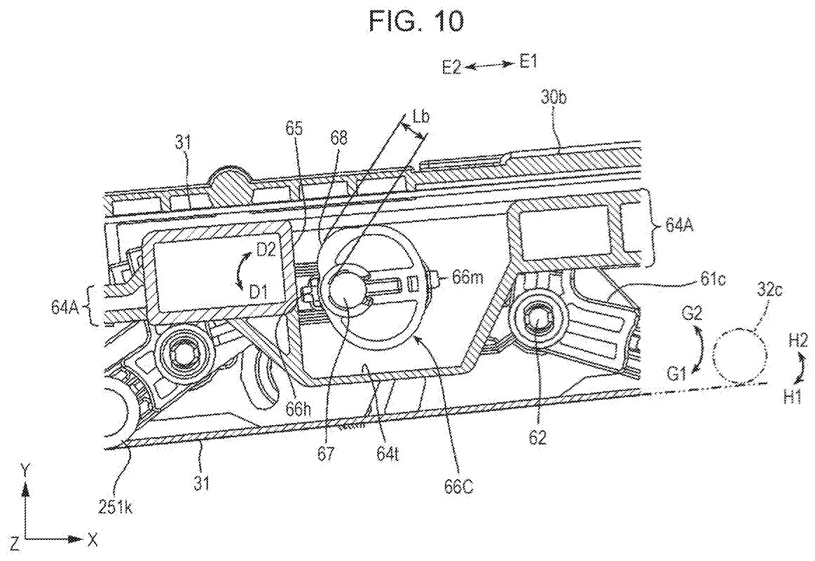

In the displacement mechanism 6, as shown in FIGS. 10 and 11, in the multicolor mode, a portion 68 of the rotating cam 66 comes into contact with a portion of the left slider 64A and moves the left slider 64A, thereby displacing the upstream-side retention roller 32c to adjust the passing position of the intermediate transfer belt 31.

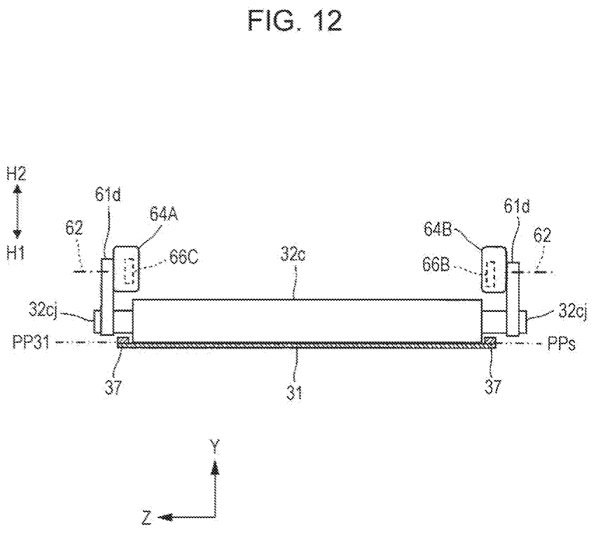

The upstream-side retention roller 32c is located immediately upstream of the first-transfer roller 251y, which is located on the extreme upstream side in the rotation direction B of the intermediate transfer belt 31. The upstream-side retention roller 32c is in contact with the inner circumferential surface of the intermediate transfer belt 31 to support the passing position of the intermediate transfer belt 31. The passing position of the intermediate transfer belt 31 is, as shown in FIGS. 11B, 12, etc., a position PP31 where the intermediate transfer belt 31 passes while being in contact with the bottom surface of the upstream-side retention roller 32c.

In the displacement mechanism 6 according to the first exemplary embodiment, an adjustment action portion 68 is provided on the left rotating cam 66A. In the multicolor mode, the adjustment action portion 68 comes into contact with the cam contact portion 65 of the left slider 64A corresponding to the left rotating cam 66A to adjust the passing position of the intermediate transfer belt 31.

Hereinbelow, the left rotating cam 66A having the adjustment action portion 68 is treated as a rotating cam 66C having the adjustment action portion 68. The right rotating cam 66B has the same configuration as the rotating cam 66C, except that right rotating cam 66B does not have the adjustment action portion 68.

As shown in FIG. 10, the adjustment action portion 68 is formed as an outwardly protruding cam portion provided at a portion between the principal action portion 66m and the non-contact portion 66h of the rotating cam 66C, the portion being closer to the non-contact portion 66h. The apex of the adjustment action portion 68 is located at a distance Lb from the rotary shaft 67. The distance Lb is set according to the amount by which the passing position of the intermediate transfer belt 31 is to be adjusted by the upstream-side retention roller 32c. The distance Lb is, at least, a value smaller than the distance La and larger than the distance between the non-contact portion 66h and the rotary shaft 67.

As shown in FIG. 11B, by changing the rotation angle of the rotating cam 66C, the adjustment action portion 68 can move the left slider 64A by a distance β at a maximum in the direction of arrow E1 from when the adjustment action portion 68 starts to come into contact with the cam contact portion 65 of the left slider 64A.

The distance β at this time is a value obtained by subtracting the distance Ls from the distance Lb (Lb−Ls). The distance β is set such that, even if the left slider 64A moves in the direction of arrow E1 by the distance β, the action projection 64p of the left slider 64A does not come into contact with the contact projections 63 of the swing support members 61y, 61m, and 61c.

Furthermore, in the displacement mechanism 6, as shown in FIGS. 3A, 3B, 7, 8, etc., left and right swing support members 61d support the shaft ends of the upstream-side retention roller 32c so as to allow displacement thereof.

The left and right swing support members 61d are formed of bent members similar to the swing support members 61 for the first-transfer rollers 251 and are attached, at the bent portions thereof, to support shafts 62d provided on the left and right side-surface portions 30a and 30b of the support frame 30, such that the swing support members 61d can swing in the directions of arrows H1 and H2 about the support shafts 62d.

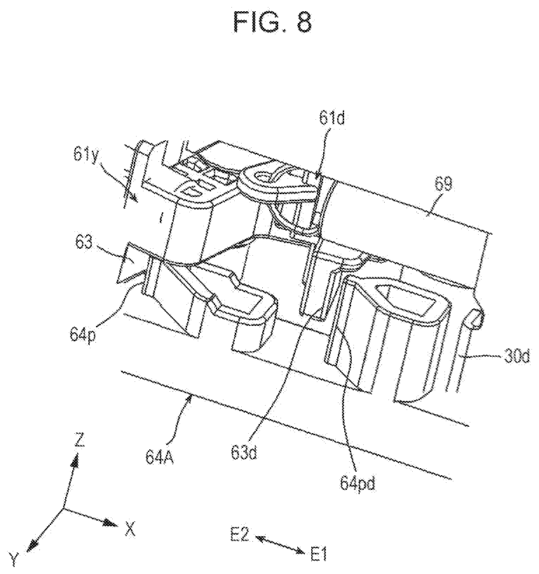

As shown in FIGS. 7, 8, etc., the swing support member 61d has a contact projection 63d, which can come into contact with a portion of the left slider 64A, in a portion extending toward the other side (for example, an upward direction) from the bent portion. In the portion extending toward the other side from the bent portion, one end of an elastic member 69, such as a coil spring, that urges the swing support member 61d in the direction of arrow H1 is provided. With this configuration, the swing support member 61d is urged in the direction of arrow H1 by the elastic member 69.

Furthermore, as shown in FIGS. 7, 8, etc., the left slider 64A has, at the end closer to the support roller 32b, an action projection 64pd that comes into contact with the contact projection 63d of the swing support member 61d to move the swing support member 61d in the direction of arrow H2.

The dimensions, shapes, and position relationships of the action projection 64pd of the left slider 64A and the contact projection 63d of the swing support member 61d are determined such that the contact state is maintained when, in the multicolor mode, the adjustment action portion 68 of the rotating cam 66 comes into contact with the cam contact portion 65 of the left slider 64A to move the left slider 64A in the directions of arrows E2 and E1.

Furthermore, as shown in FIGS. 3A, 3B, and 5, the image forming apparatus 1 includes a position detecting sensor 18, serving as an example of a measuring device, that measures the shifting characteristics of the intermediate transfer belt 31. The rotation angle of the rotating cam 66C is adjusted by the cam driver 17 according to the shifting characteristics measured by the position detecting sensor 18.

The shifting characteristics of the intermediate transfer belt 31 are time-lapse information about the position where at least one of the left and right ends of the intermediate transfer belt 31 parallel to the rotation direction B passes, in the multicolor mode (i.e., the position with respect to the axis of rotation). The position detecting sensor 18 detects the position of one of the left and right ends of the intermediate transfer belt 31 and performs measurement related to the shifting characteristics of the intermediate transfer belt 31 by aggregating the detected information.

Furthermore, the rotation angle of the rotating cam 66C is adjusted by the cam driver 17 when the cam driver 17 is actuated under the control by the control unit 15, which is actuated according to the measurement information from the position detecting sensor 18.

In the displacement mechanism 6, when the image forming apparatus 1 is switched from the monochrome mode to the multicolor mode to perform an image forming operation, as shown in FIG. 11A, the left rotating cam 66C is rotated by a certain angle such that the non-contact portion 66h faces the cam contact portion 65 of the left slider 64A and is brought into a state not in contact with the cam contact portions 65, similarly to the case of the right rotating cam 66B (FIGS. 3A and 6).

As a result, similarly to the right slider 64B, because the left slider 64A is brought into a state not subjected to an action from the rotating cam 66C, the left slider 64A becomes movable in the direction of arrow E1 by receiving the urging force from the swing support members 61y, 61m, and 61c urged in the direction of arrow G1.

As a result, in the displacement mechanism 6, as shown in FIG. 3A, the swing support members 61y, 61m, and 61c swing in the direction of arrow G1 about the support shafts 62, displacing the first-transfer rollers 251y, 251m, and 251c from the retracted positions to the transfer positions.

In the displacement mechanism 6 at this time, the swing support members 61d swing in the direction of arrow H1 about the support shafts 62d, displacing the upstream-side retention roller 32c from the retracted position to a home position in the multicolor mode.

As a result, the intermediate transfer belt 31 runs in the direction of arrow B while the passing position thereof in the upstream-side retention roller 32c before moving to the first-transfer roller 251y on the extreme upstream side is maintained constant.

Furthermore, in the displacement mechanism 6, before an image forming operation in multicolor mode is started, the measurement information obtained by the position detecting sensor 18 is inputted to the control unit 15, and the shifting characteristics of the intermediate transfer belt 31 are checked.

At this time, if it is determined by the control unit 15 that the running position of the intermediate transfer belt 31 with respect to the axial direction is unstable, the cam driver 17 is actuated, rotating the rotary shaft 67 to rotate the rotating cams 66B and 66C by a certain angle. The determination of whether the running position of the intermediate transfer belt 31 with respect to the axial direction is unstable or not is performed by, for example, checking if the degree of misregistration of a toner image for a control purpose (patch image) first-transferred to the intermediate transfer belt 31 in the setup of an image forming operation in multicolor mode is within an allowable range or not.

Because there is no adjustment action portion 68 for the right rotating cam 66B, the right rotating cam 66B is brought into a state not in contact with the cam contact portion 65 of the right slider 64B (FIG. 6). Hence, the right slider 64B at this time is not moved by the rotating cam 66C.

Meanwhile, as shown in FIG. 11B, the adjustment action portion 68 of the left rotating cam 66C comes into contact with the cam contact portion 65 of the left slider 64A.

Hence, the left slider 64A moves in the direction of arrow E2, according to the degree of contact between the adjustment action portion 68 and the cam contact portion 65. Although the left slider 64A is movable by the distance β at a maximum, the left slider 64A may move in the direction of arrow E2 by a distance smaller than the distance β, depending on the rotation angle of the rotating cam 66C.

Because the action projection 64pd of the right slider 64B does not come into contact with the contact projection 63d of the right swing support member 61d, the right swing support member 61d does not swing in the direction of arrow H2 (including arrow H1), and thus, the right end of the upstream-side retention roller 32c is not displaced.

Meanwhile, because the action projection 64pd of the left slider 64A comes into contact with the contact projection 63d of the left swing support member 61d, the left swing support member 61d swings in the direction of arrow H2 by an angle corresponding to the amount of movement of the left slider 64A, and thus, the left end of the upstream-side retention roller 32c is displaced upward in the direction of arrow H2.

The degree of contact between the adjustment action portion 68 and the cam contact portion 65 of the left slider 64A varies with the rotation angle of the rotating cam 66C. Hence, not only it is possible to move the left slider 64A in the direction of arrow E2, but also to bring a portion of the adjustment action portion 68 other than the apex into contact with the cam contact portion 65 to move the cam contact portion 65 in the direction of arrow E1. The rotating cam 66C may be rotated either in the direction of arrow D1 or the direction of arrow D2 to adjust the contact state of the adjustment action portion 68.

As a result, as shown in FIG. 12, the right end of the upstream-side retention roller 32c is located at a normal position in the multicolor mode, whereas the left end of the upstream-side retention roller 32c is displaced upward as indicated by arrow H2. Hence, the passing position PP31 where the intermediate transfer belt 31 passes is changed and adjusted. As a result, when passing through the upstream-side retention roller 32c, the position of the intermediate transfer belt 31 in the axial direction is changed, and the running state is adjusted.

Accordingly, in the image forming apparatus 1, when an image forming operation in multicolor mode is performed, the displacement mechanism 6 adjusts the passing position of the intermediate transfer belt 31 via the upstream-side retention roller 32c to suppress unstable running of the intermediate transfer belt 31. Hence, color misregistration, which is an example of image misregistration (toner image misregistration) in the axial direction, caused by unstable running of the intermediate transfer belt 31 occurring when a multicolored image is formed, is suppressed.

When the result of measurement of the shifting characteristics performed by the position detecting sensor 18 shows that the intermediate transfer belt 31 is not shifted toward one side in the axial direction of the intermediate transfer belt 31 or that the shifting characteristics do not fluctuate, the displacement mechanism 6 performs the following operation.

Specifically, in the multicolor mode, by rotating the rotating cam 66C with the cam driver 17 (at this time, the right rotating cam 66B is also rotated), the passing position PP31 of the intermediate transfer belt 31 on the upstream-side retention roller 32c is adjusted such that the intermediate transfer belt 31 is shifted toward one of the left and right ends. More specifically, the left end of the upstream-side retention roller 32c is displaced in the direction of arrow H2.

Because this makes the intermediate transfer belt 31 run in a state of being shifted toward one of the left and right ends, running of the intermediate transfer belt 31 is less likely to become unstable, and color misregistration occurring in forming a multicolored image is suppressed.

Furthermore, when the result of measurement of the shifting characteristics performed by the position detecting sensor 18 shows that the intermediate transfer belt 31 is shifted toward one side in the axial direction of the intermediate transfer belt 31, the displacement mechanism 6 performs the following operation.

Specifically, in the multicolor mode, by rotating the rotating cam 66C with the cam driver 17 (the right rotating cam 66B is also rotated), the passing position PP31 of the intermediate transfer belt 31 on the upstream-side retention roller 32c is adjusted such that the intermediate transfer belt 31 is shifted toward the end opposite to the end to which the intermediate transfer belt 31 has been shifted. More specifically, the left end of the upstream-side retention roller 32c is displaced in the direction of arrow H2.

This makes the intermediate transfer belt 31 run in a state of being shifted toward the side opposite to the side to which the intermediate transfer belt 31 has been shifted, and thus, the intermediate transfer belt 31 is inhibited from continuing to run in a state of being shifted toward one side in the axial direction. Thus, color misregistration occurring in forming a multicolored image is suppressed, and the following advantages are obtained.

That is, if the intermediate transfer belt 31 runs in a state of being shifted toward one side, the intermediate transfer belt 31 continues to run in a state in which the belt rib 37 on the intermediate transfer belt 31 is on the corresponding one of the guide surfaces 38g of the rib guides 38 at the left and right ends of the support roller 32a etc. As a result, the corresponding end of the intermediate transfer belt 31 is maintained in a deflected state and is bent at a certain point in time, potentially leading to fracture of the intermediate transfer belt 31. However, by adjusting the passing position of the intermediate transfer belt 31 with the displacement mechanism 6, fracture of the intermediate transfer belt 31 is less likely to occur.

### Modification

The present disclosure is not limited to the configuration according to the first exemplary embodiment, but includes the following modifications.

Although the adjustment, using the displacement mechanism 6, of the passing position of the intermediate transfer belt 31 on the upstream-side retention roller 32c in the multicolor mode may be performed in, at least, pre-shipping inspection of the image forming apparatus 1, the adjustment may be performed when a user uses the image forming apparatus 1.

In the first exemplary embodiment, a configuration example has been described in which the left rotating cam 66A is configured as the rotating cam 66C having the adjustment action portion 68, and the passing position of the intermediate transfer belt 31 on the upstream-side retention roller 32c is adjusted by moving the left slider 64A in the multicolor mode. However, it is also possible to configure such that the right rotating cam 66B serves as the rotating cam 66C having the adjustment action portion 68, and the passing position of the intermediate transfer belt 31 on the upstream-side retention roller 32c is adjusted by moving the right slider 64B in the multicolor mode.

In the first exemplary embodiment, a configuration example has been described in which, in the multicolor mode, the passing position of the intermediate transfer belt 31 on the upstream-side retention roller 32c is adjusted by using the displacement mechanism 6, it is also possible to configure such that the passing position of the intermediate transfer belt 31 on the downstream-side retention roller 32d is adjusted, if necessary. In this case, the downstream-side retention roller 32d is a retention roller that is disposed immediately downstream of the first-transfer roller 251k, which is located on the extreme downstream side in the rotation direction B of the intermediate transfer belt 31, and is in contact with the inner circumferential surface of the intermediate transfer belt 31 to support the passing position of the intermediate transfer belt 31.

In the exemplary embodiment, although the image forming apparatus 1 having four image forming units 2Y, 2M, 2C, and 2K, which form four different color toner images, has been described as an example, the present disclosure may be applied to any image forming apparatus that has two or more image forming units 2 and employs an intermediate transfer method.

The image forming units 2 are not limited to those that form toner images of different colors, but may be those that form toner images of the same color or those (in this case, three or more) that form toner images including one in a different color than the rest.

Image misregistration in this disclosure is not limited to one occurring between toner images of different colors, but includes one occurring between toner images of the same color when, for example, multiple toner images of the same color are formed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An image forming apparatus comprising:
a plurality of image forming units that form toner images;
an intermediate transfer belt that rotates so as to pass through the plurality of image forming units;
a plurality of first-transfer rollers that are provided in a manner capable of being displaced between transfer positions, where the first-transfer rollers make the intermediate transfer belt come into contact with the plurality of image forming units, and retracted positions, where the first-transfer rollers make the intermediate transfer belt be separated from the plurality of image forming units, and that first-transfer the toner images to the intermediate transfer belt when the first-transfer rollers are located at the transfer positions;
a displacement mechanism including a moving unit that comes into contact with and moves a first-transfer roller that is not involved in transfer in a first mode, in which an image is formed with one image forming unit, among the plurality of first-transfer rollers of the image forming units, so as to be displace the first transfer roller to the retracted position, and a rotating cam that comes into contact with a portion of the moving unit to move the moving unit in the first mode; and
an upstream-side retention roller in contact with an inner circumferential surface of the intermediate transfer belt and supporting passing positions of the intermediate transfer belt at a position immediately upstream of the first-transfer roller that is disposed on the extreme upstream side in the rotation direction of the intermediate transfer belt,
wherein, in a second mode, in which an image is formed with two or more image forming units of the image forming units, and when all the first-transfer rollers are located at the transfer positions, the displacement mechanism adjusts the passing position of the intermediate transfer belt by bringing a portion of the rotating cam into contact with the moving unit to move the moving unit and thus displacing one of the upstream-side and downstream-side retention rollers,
wherein the moving unit includes left and right moving units provided on left and right sides of the intermediate transfer belt in the rotation direction thereof,
the rotating cam includes a left cam and a right cam that come into contact with portions of the left and right moving units and act thereon, and
either the left cam or the right cam has an adjustment action portion that comes into contact with a portion of the moving unit on the side corresponding to the rotating cam to adjust the passing position of the intermediate transfer belt in the second mode.

2. The image forming apparatus according to claim 1, wherein, in the upstream-side retention roller, the passing position of the intermediate transfer belt is adjusted in the second mode.

3. (canceled)

4. The image forming apparatus according to claim 2, wherein
the moving unit includes left and right moving units provided on the left and right sides of the intermediate transfer belt in the rotation direction thereof,
the rotating cam includes left and right rotating cams that come into contact with portions of the left and right moving units and act thereon, and
one of the left and right rotating cams has an adjustment action portion that comes into contact with a portion of the moving unit on the side corresponding to the rotating cam to adjust the passing position of the intermediate transfer belt in the second mode.

5. The image forming apparatus according to claim 1, further comprising:
a measuring device that measures shifting characteristics of the intermediate transfer belt; and
a cam driving part that adjusts a rotation angle of the rotating cams to correct the shifting characteristics measured by the measuring device.

6. The image forming apparatus according to claim 2, further comprising:
a measuring device that measures shifting characteristics of the intermediate transfer belt; and
a cam driving part that adjusts a rotation angle of the rotating cams to correct the shifting characteristics measured by the measuring device.

7. (canceled)

8. The image forming apparatus according to claim 4, further comprising:
a measuring device that measures shifting characteristics of the intermediate transfer belt; and
a cam driving part that adjusts a rotation angle of the rotating cams to correct the shifting characteristics measured by the measuring device.

9. The image forming apparatus according to claim 5, wherein, when the measurement result of the shifting characteristics shows that the intermediate transfer belt is not shifted toward the left end or the right end of the intermediate transfer belt or that the shifting characteristics do not fluctuate, the passing position of the intermediate transfer belt on one of the upstream-side and downstream-side retention rollers is adjusted such that the intermediate transfer belt is shifted toward one of the left and right ends by rotating the rotating cams with the cam driving part in the second mode.

10. The image forming apparatus according to claim 6, wherein, when the measurement result of the shifting characteristics shows that the intermediate transfer belt is not shifted toward the left end or the right end of the intermediate transfer belt or that the shifting characteristics do not fluctuate, the passing position of the intermediate transfer belt on one of the upstream-side and downstream-side retention rollers is adjusted such that the intermediate transfer belt is shifted toward one of the left and right ends by rotating the rotating cams with the cam driving part in the second mode.

11. (canceled)

12. The image forming apparatus according to claim 8, wherein, when the measurement result of the shifting characteristics shows that the intermediate transfer belt is not shifted toward the left end or the right end of the intermediate transfer belt or that the shifting characteristics do not fluctuate, the passing position of the intermediate transfer belt on one of the upstream-side and downstream-side retention rollers is adjusted such that the intermediate transfer belt is shifted toward one of the left and right ends by rotating the rotating cams with the cam driving part in the second mode.

13. The image forming apparatus according to claim 5, wherein, when the measurement result of the shifting characteristics shows that the intermediate transfer belt is shifted toward one of the left and right ends, the passing position of the intermediate transfer belt on one of the upstream-side and downstream-side retention rollers is adjusted such that the intermediate transfer belt is shifted toward the side opposite to the side to which the intermediate transfer belt has been shifted by rotating the rotating cams with the cam driving part in the second mode.

14. The image forming apparatus according to claim 6, wherein, when the measurement result of the shifting characteristics shows that the intermediate transfer belt is shifted toward one of the left and right ends, the passing position of the intermediate transfer belt on one of the upstream-side and downstream-side retention rollers is adjusted such that the intermediate transfer belt is shifted toward the side opposite to the side to which the intermediate transfer belt has been shifted by rotating the rotating cams with the cam driving part in the second mode.

15. (canceled)

16. The image forming apparatus according to claim 8, wherein, when the measurement result of the shifting characteristics shows that the intermediate transfer belt is shifted toward one of the left and right ends, the passing position of the intermediate transfer belt on one of the upstream-side and downstream-side retention rollers is adjusted such that the intermediate transfer belt is shifted toward the side opposite to the side to which the intermediate transfer belt has been shifted by rotating the rotating cams with the cam driving part in the second mode.

17. The image forming apparatus according to claim 9, wherein, when the measurement result of the shifting characteristics shows that the intermediate transfer belt is shifted toward one of the left and right ends, the passing position of the intermediate transfer belt on one of the upstream-side and downstream-side retention rollers is adjusted such that the intermediate transfer belt is shifted toward the side opposite to the side to which the intermediate transfer belt has been shifted by rotating the rotating cams with the cam driving part in the second mode.

18. The image forming apparatus according to claim 10, wherein, when the measurement result of the shifting characteristics shows that the intermediate transfer belt is shifted toward one of the left and right ends, the passing position of the intermediate transfer belt on one of the upstream-side and downstream-side retention rollers is adjusted such that the intermediate transfer belt is shifted toward the side opposite to the side to which the intermediate transfer belt has been shifted by rotating the rotating cams with the cam driving part in the second mode.

19. (canceled)

20. The image forming apparatus according to claim 12, wherein, when the measurement result of the shifting characteristics shows that the intermediate transfer belt is shifted toward one of the left and right ends, the passing position of the intermediate transfer belt on one of the upstream-side and downstream-side retention rollers is adjusted such that the intermediate transfer belt is shifted toward the side opposite to the side to which the intermediate transfer belt has been shifted by rotating the rotating cams with the cam driving part in the second mode.
